(19) United States
(12) Patent Application Publication
(10) Pub. No.: US 2011/0125401 A1
(43) Pub. Date: May 26, 2011

(54) UPDATE UNIT AND METHOD FOR UPDATING A DIGITAL MAP

(75) Inventor: Ulrich Stählin, Eschborn (DE)

(73) Assignee: Continental Teves AG & Co. oHG, Frankfurt (DE)

(21) Appl. No.: 12/674,511

(22) PCT Filed: Apr. 23, 2008
(86) PCT No.: PCT/EP2008/054917

§ 371 Date: Feb. 22, 2010

(30) Foreign Application Priority Data
Aug. 25, 2007 (DE) 102007040188.6
Mar. 5, 2008 (DE) 102008012661.6

(51) Int. Cl. G01C 21/32

(52) U.S. Cl. 701/208

(57) ABSTRACT

An update device for updating a digital map for a vehicle is specified which has a multiplicity of sensors which measure the current traffic situation, the movement of the vehicle or else the road conditions. These measured values are transferred to a control center which evaluates them and then sends appropriate update data for updating the digital map to other vehicles.

### CROSS REFERENCE TO RELATED APPLICATIONS

This application is the U.S. national phase application of PCT International Application No. PCT/EP2008/054917, filed Apr. 23, 2008, which claims priority to German Patent Application No. DE 10 2007 040 188.6, filed Aug. 25, 2007, and German Patent Application No. 10 2008 012 661.6, filed Mar. 5, 2008, the contents of such applications being incorporated herein by reference.

### FIELD OF THE INVENTION

The invention relates to navigation and safety engineering for vehicles. In particular, the invention relates to an update device for updating a digital map for a vehicle, an update system, the use of an update device in a vehicle, a method for updating a digital map, a computer program product and a computer-readable medium.

### BACKGROUND OF THE INVENTION

The rapid increase in vehicle traffic on the roads and the associated queues and travel time extensions are resulting in increased efforts worldwide to identify traffic states and to take them into account for the route selection or for route calculation in navigation systems.

If the geographical coordinates measured using a position-finding method are mapped directly to the coordinate system of a digital map, the true position of the object in the map may differ from the mapped position of the object in the map. The reason for this may firstly be measurement errors in the position-finding method and secondly inaccuracies in the map.

Since a navigation system needs to know the true position in the map, the map matching method aligns the measured position with the map information about the position and geometry of objects in the map, so that the most probable position of the object in the map is ascertained.

In vehicle navigation systems, the position of the vehicle is usually measured with the assistance of the satellite position-finding system GPS. The correctness of the measured and actual positions is specified at approximately 15 m in the case of GPS. Similarly, the digital map may have tolerances in the region of meters. The navigation appliance then needs to ascertain the position of the vehicle in the digital map so that, by way of example, it is possible to determine a meaningful route calculation from the current location to the destination of travel. Without alignment of the measured position with the map information, the vehicle could find itself outside of the digitalized roads or on the wrong road in the map. Since the position of the vehicle in the digital map is critical for the navigation appliance, the measured position is aligned with the map information such that the most probable location of the vehicle in the map is ascertained for the navigation. In this regard, map matching involves utilizing the knowledge about the movements of the vehicle.

Digital maps are usually outdated as soon as they are delivered. For this reason, an update for the map is indispensible if the digital map is intended to correspond to the current circumstances. However, these updates comprise a large volume of data, since the whole map is always brought up to date.

It is known that vehicles send what are known as “Floating Car Data” (FCD). The system used for this comprises a GPS (Global Positioning System) receiver and a GSM (Global System for Mobile Communication) module (or alternatively UMTS/WiMax). Both modules are already present in many vehicles even without FCD functionality. The GPS receiver measures the position. Preprocessing takes place in the vehicle, and then data from said preprocessing are sent to the control center. The latter can use the data to make inferences about the traffic situation. In this way, traffic state data are collected for traffic information services.

### SUMMARY OF THE INVENTION

It is an object of the invention to provide an improved up-to-date digital map representing the current ambient conditions.

The invention specifies an update device for updating a digital map for a vehicle, an update system, the use of an update device in a vehicle, a method for updating a digital map in a vehicle, a computer program product and a computer-readable medium.

The exemplary embodiments described relate in equal measure to the update device, the update system, the method, the use, the computer program product and the computer-readable medium.

In line with one exemplary embodiment of the invention, an update device for updating a digital map for a vehicle is specified which has a capture unit in the vehicle for capturing measured values, a communication unit for transmitting measurement data which are based on the measured values to a control center and for receiving update data from the control center, and also an update unit for updating the digital map on the basis of the update data, wherein the update data are based on the measurement data.

In other words, the update device in conjunction with the control center is able to produce additional, up-to-date information which can be used to update or supplement a digital map. For this, the capture unit captures one or a multiplicity of in some cases totally different measured values which it can forward to the control center via the communication unit. The control center evaluates the transmitted measurement data. The evaluation can actually take place at least to some extent within the update device. On the basis of the evaluation of the measurement data, the control center then generates appropriate update data which are transmitted to the update device and/or also to other vehicles.

These update data may firstly be additional data for the digital map or else may also be dynamic information which can be transmitted using the TMC (Traffic Message Channel), for example. The dynamic information may contain information about queues and other traffic information. It is not necessary to intervene in the digital map data in order to forward said information to the driver. In this case, updating the digital map is intended to be understood to mean the transmission of the additional information to the driver, who receives and evaluates said information together with the map information.

The update device can therefore be used to produce a highly up-to-date safety map having multilayer information.

In line with a further exemplary embodiment of the invention, the capture unit has at least one sensor which is selected from the group comprising GPS sensor, ambient sensor, ESP sensor, camera, ABS sensor, ASR sensor and speed sensor.

It is thus possible to transmit a multiplicity of different measured values to the control center. In this way, the information content of the safety map can be increased.

In line with a further exemplary embodiment of the invention, the control center is a traffic data control center as a service provider.

In line with a further exemplary embodiment of the invention, the captured measured values are conditioned in the vehicle before they are transmitted to the control center as measurement data.

It is thus possible to make a preselection within the actual vehicle regarding which measured values need to be transmitted to the control center. In addition, the measured values can be conditioned such that they comply with a particular standard, which means that the computition power required in the control center can be reduced.

In line with a further exemplary embodiment of the invention, the update unit is designed to produce a safety map on the basis of the update of the digital map, wherein the safety map contains safety-relevant information about a current road situation.

In this way, it is possible to increase road safety.

In line with a further exemplary embodiment of the invention, the digital map is a digital navigation map.

The general term “digital map” is also intended to be understood to mean maps for ADAS (Advanced Driver Assistance System), without this involving any navigation taking place. One example of this is the “Map and Positioning Engine” MPE from Navteq.

In line with a further exemplary embodiment of the invention, an update system for updating digital maps for a multiplicity of vehicles is specified, wherein the update system has an update device as described above and a control center. The control center is designed to receive measurement data from the update device and to transmit update data to the update device. In addition, the control center produces the update data on the basis of the measurement data.

The update system is thus a system having a central controller (control center), for example in the form of a server which uses a wireless communication link to communicate with the individual update devices of the various vehicles. The data are transmitted between the control center and the update device on the basis of UMTS, GSM/GPRS, WLAN or, by way of example, WiMax.

In line with a further exemplary embodiment of the invention, the control center is designed to individually transmit individualized update data to the multiplicity of vehicles.

In other words, the control center can send each of the vehicles quite specific, selected update data attuned to the vehicle. By way of example, the update data may differ from vehicle to vehicle, depending on the location at which the relevant vehicle is situated. Hence, by way of example, a first vehicle requires only update data for a first portion of the digital map, whereas a second vehicle requires an update for a totally different, second portion of the digital map.

This allows the data traffic to be reduced further.

In line with a further exemplary embodiment, the same data can be transmitted to all subscribers in a broadcast mode.

In line with a further exemplary embodiment of the invention, the control center is designed to receive measurement data from a multiplicity of communication devices from different vehicles and to produce the update data on the basis of all the received measurement data.

By way of example, the control center can also receive measurement data from sensors outside of the vehicles, for example from induction loops in a road or from detectors at the edge of the road or underneath a bridge.

In line with a further exemplary embodiment of the invention, the control center is designed to statistically condition the measurement data for the purpose of producing the update data.

The statistical conditioning may also involve the use of methods of data mining, for example. Data mining is understood to mean the application of statistical mathematical methods to a stock of data with the aim of pattern recognition.

In this way, it is possible to average out individual mismeasurements, which allows the validity of the update data to be increased.

In line with a further exemplary embodiment of the invention, the use of an update device as described above in a vehicle is specified.

By way of example, the vehicle is a motor vehicle, such as a car, bus or heavy goods vehicle, or else a rail vehicle, a ship, an aircraft, such as a helicopter or airplane, or, by way of example, a bicycle.

In line with a further exemplary embodiment of the invention, a method for updating a digital map in a vehicle is specified in which measured values are captured by a capture unit in the vehicle, measurement data which are based on the measured values are transmitted from the vehicle to a control center, update data are produced on the basis of the measurement data in the control center, the update data, which are based on the measurement data, are transmitted from the control center to an update unit, and the digital map is updated on the basis of the update data.

In line with a further exemplary embodiment of the invention, the capture of measured values in the vehicle comprises the ascertainment of a vehicle speed in a GPS position of the vehicle, the ascertainment of distances from other vehicles using ambient sensors, the ascertainment of information about the roadbase using ESP sensors, the ascertainment of safety conditions using an ambient sensor system, the ascertainment of lanes using cameras or the ascertainment of ABS and/or ESP and/or ASR interventions.

In line with a further exemplary embodiment of the invention, the transmission is preceded by the performance of a comparison with data in the digital map. In this way, it is possible to accurately identify the position on the map.

In line with a further exemplary embodiment of the invention, a computer program product is specified which, when executed on a processor, instructs the processor to perform the method steps specified above.

In line with a further exemplary embodiment of the invention, a computer-readable medium is specified which stores a computer program product which, when executed on a processor, instructs the processor to perform the method steps specified above.

In the case of a safety-oriented digital map, such as a digital navigation map (safety map), it is important always to have up-to-date data available. These can be obtained via floating car data, for example. To this end, all vehicles involved send their known data about what is happening in the traffic and the course or state of the road to a traffic data control center, which then conditions them and distributes them to all other vehicles. In this context, the conditioning serves to ascertain statements about the road and hence to be able to enter road works, queues, accidents, oil on the road, poor road conditions or the like, for example, into the digital map.

A fundamental consideration of the invention is that it allows the simultaneous use of data from very many vehicles, which means that it is possible to obtain more accurate and more up-to-date data for an up-to-date digital map.

### BRIEF DESCRIPTION OF THE DRAWINGS

The invention is best understood from the following detailed description when read in connection with the accompanying drawings. Included in the drawings are the following figures:

FIG. 1 shows a schematic illustration of an update device based on an exemplary embodiment of the invention.

FIG. 2 shows a schematic illustration of an update system based on an exemplary embodiment of the invention.

FIG. 3 shows a schematic illustration of a detail from a digital map based on an exemplary embodiment of the invention.

FIG. 4 shows a flowchart for a method based on an exemplary embodiment of the invention.

The illustrations in the figures are schematic and not to scale.

### DETAILED DESCRIPTION OF THE PREFERRED EMBODIMENTS

In the description of the figures which follows, the same reference numerals are used for the same or similar elements.

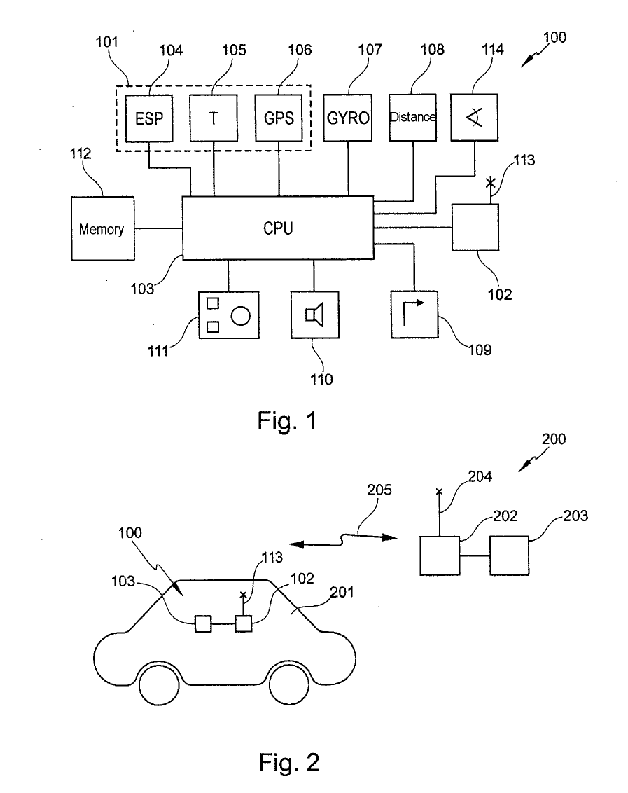

FIG. 1 shows a schematic illustration of components of an update device 100 which is installed in a vehicle, for example, and is used to update a digital map, such as a digital navigation map. The update device 100 has a capture unit 101, a communication unit 102 and an update unit 103.

The capture unit 101 comprises a multiplicity of different sensors, such as a GPS unit 106, a temperature sensor 105 and an ESP system 104.

The communication unit 102 has an antenna 103 which can be used for wireless communication with a server (see reference 203 in FIG. 2).

The update unit 103 is used firstly for updating the digital maps and secondly also for controlling the update device, however.

The update unit 103 or the controller 103 has an input unit 111 connected to it. The input unit 111 can be used to make various settings on the update unit and to select a destination and possibly also a location for a navigation unit, for example. In this case, it is possible to input the destination by inputting the full name of the destination, for example, or else by selecting from a list which is shown on a visual output unit, such as a monitor 109. The monitor 109 is also used to output the routing information. Furthermore, the routing information can also be output via an audible output unit 110. The audible output unit 110 can also be used to output particular update data transmitted by the control center, such as warnings. Output via an audible output unit 110 has the advantage that the driver is less distracted from what is currently happening in the traffic. A memory element 112 which is connected to or integrated with the controller 103 stores the digital map data in the form of data records. By way of example, the memory element 112 also stores additional information about traffic restrictions and the like in association with the data records.

To determine the current vehicle position, the update device 100 has a navigation unit 106 with a GPS receiver which is designed to receive position signals from GPS satellites. Naturally, the navigation unit 106 with the GPS receiver may also be designed for other satellite navigation systems.

Since it is not always possible to receive the GPS signals in city centers, for example, however, the device 100 also has a direction sensor 107, a distance sensor 108 and possibly also a steering wheel angle sensor 114 for performing compound navigation. Signals from the GPS receiver, from the distance sensor, from the direction sensor and/or from the steering wheel angle sensor are handled in the control device 103, for example. The vehicle position ascertained from said signals is aligned with the roadmaps using map matching. The routing information obtained in this manner is finally output via the monitor 109.

The data required for updating the digital map are ascertained as follows, for example:
(A) The measured speed and the GPS position can be used to examine the course of the road, including the level profile thereof. In this way, it is possible to identify whether there are road works or there is a queue, for example. By way of example, it is possible to identify whether the vehicle keeps in lane or leaves the road. In this way, it is possible to make a statement about whether the road course indicated on the map matches the actual movement of the vehicle. If this is not the case, information about altered routes can be ascertained.
(B) If the vehicle has ambient sensors, said ambient sensors can be used to measure the distances from other vehicles. In this way, it is possible to make statements about a flow of traffic and about any queues.
(C) ESP (Electronic Stability Program, may also contain traction control system) can be used to draw conclusions about the roadbase.
(D) An ambient sensor system, such as cameras or distance detectors, can be used to make statements about the visibility conditions, road conditions or weather conditions. Thus, the ambient sensors identify rain, fog, visibilities and ambient temperatures, for example.
(E) Cameras can be used to identify lanes. The lanes are the area between two lane marking lanes. In this way, it is possible to detect an altered route without needing to use GPS data for this purpose.
(F) By way of example, interventions by the ABS (Antilock Braking System), the TCS (Traction Control System) or the ESP, possibly in combination with the GPS position and the current speed, can be used to make statements about the road conditions. An appropriate statistical evaluation on the basis of the number of interventions made per unit time, the speed of travel at this time, the current temperature or else the time of day can be used to make an exact statement about the actual road conditions.

In this context, the map (safety map) available in the vehicle is continuously updated via a traffic data control center, which may also be a service provider.

By way of example, the update device can trigger the transmission of the measurement data when it recognizes that a particular situation is present. For this, it compares the data from its up-to-date digital map, for example, with the measurements from its sensors. As soon as there is a significant discrepancy, the relevant measured values, possibly in already conditioned or filtered form, are transmitted to the control center. The control center can then react thereto by requesting further data from other vehicles, for example in order to allow a statistical evaluation and to lower the risk of distortion of the actual situation on account of a mismeasurement.

Since modern vehicles contain many driver assistance systems, such as ABS, TCS, ESP, rain sensors and much more, these data can be transferred to a control unit 103 or telematics unit. Said telematics unit then evaluates all data from the car electronics according to particular algorithms for different situations.

By way of example, the system recognizes from ABS and ESP data that there is a prevalence of black ice at a point which has just been passed. The appliance sends these details to the traffic control center under situation control. The traffic control center examines the data again for plausibility, for example, by attempting whether from this point the same results have been sent from other vehicles. If this is the case, the control center sends a warning for this position so that a motor vehicle driver can adapt to this new, dangerous situation in good time. It is thus possible for a car driver to be warned of hazards, such as ice, rain, fog, in good time, which in turn helps to prevent serious accidents. On the basis of the data from the control center, the digital map in the respective addressed vehicles is updated and the warning is visually displayed or else brought to the driver's attention audibly.

The evaluation of the different data during the journey provides some indication of traffic states, visibility restrictions, road states (road surfacing), infrastructural circumstances (zigzag mountain roads), local hazards, precipitation, icy roads and slip hazards. In this case, measured variables ascertained locally in the vehicle are converted into a local traffic state relating to the surroundings of the vehicle. As a result of the inclusion of traffic information which is already available in the vehicle and which, by way of example, is received by mobile radio or by Radio Data System-Traffic Message Channel (RDS-TMC), the system establishes whether the locally ascertained traffic state differs from the state which is known in the traffic data control center. Then and only then is an appropriate message sent, so that the volume of communication caused by the message is minimized.

In the traffic data control center, the messages are combined together with the data collected from other sources (e.g. induction loop detectors or traffic cameras) using statistical methods and methods of data mining to form a regional traffic state (regional traffic description object).

FIG. 2 shows a schematic illustration of an update system with an update device 100 and a control center 200.

The update device 100 comprises the update unit 103 with the appropriate sensors connected thereto and other appliances, and also a communication unit 102 for communicating with the control center 200. The update device 100 is incorporated in a vehicle 201.

The control center 200 likewise comprises a communication unit 202 with an appropriate antenna 204, and the server 203.

The control center 200 and the update device 100 communicate wirelessly via the radio transmission link 205.

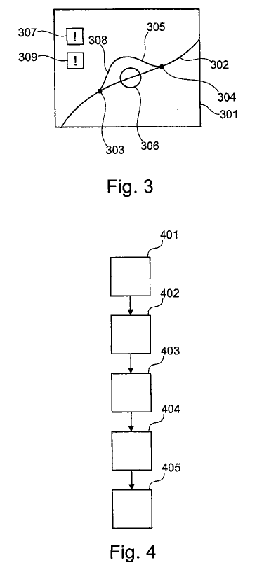

FIG. 3 shows a detail 301 from a digital map, which is a navigation map. A road 302 can be seen which connects the two locations 303 and 304 to one another. In addition, a bypass route 305 is displayed for bypassing the accident location 306. Since there is black ice at the location 308 on the bypass route 305, an appropriate warning 309 is displayed. There may also be an audible warning, for example transmitted by TMC. The additional warning 307 warns of the accident location 306.

The black ice warning and the knowledge of the accident location are based on measurements which have been performed by vehicles which have passed the relevant map section at an earlier time and have then transmitted their measurement data to the control center. The control center has analyzed the measurement data, statistically averaged them and evaluated them, and has then transmitted the relevant warnings to the other vehicles. In addition, the control center has also transmitted update data for the new routing 305.

FIG. 4 shows a flowchart for a method based on an exemplary embodiment of the invention. In step 401, measured values are captured in the vehicle. Said measured values are compared with the already available data from a digital map, for example, in a subsequent step 402, and any discrepancies are ascertained. In step 403, measurement data which correspond to the measurement values or which have already been preprocessed (e.g. discrepancies from already available information) are transmitted to the control center. In the next step 404, the control center produces update data on the basis of the measurement data, and in step 405, the control center transmits said update data to other vehicles. Finally, in step 406, the digital maps are updated in the respective vehicles on the basis of the transmitted and received update data.

In addition, it should be pointed out that “comprising” and “having” do not exclude other elements or steps, and “a” or “an” does not exclude a large number. Furthermore, it should be pointed out that features or steps which have been described with reference to one of the above exemplary embodiments can also be used in combination with other features or steps from other exemplary embodiments described above.

1-16. (canceled)

17. An update device for updating a digital map for a vehicle, said update device comprising:
a capture unit in the vehicle for capturing measured values;
a communication unit for transmitting measurement data, which are based on the measured values, to a control center and for receiving update data from the control center;
an update unit for updating the digital map on the basis of the update data;
wherein the update data are based on the measurement data.

18. The update device as claimed in claim 17,
wherein the capture unit has at least one sensor selected from the group consisting of a GPS sensor, an ambient sensor, an ESP sensor, a camera, an ABS sensor, an ASR sensor and a speed sensor.

19. The update device as claimed in claim 17,
wherein the control center is a traffic data control center as a service provider.

20. The update device as claimed in claim 17,
wherein the update device is configured to condition the captured measured values in the vehicle before captured and conditioned measured values are transmitted to the control center as measurement data.

21. The update device as claimed in claim 17,
wherein the update unit is configured to produce a safety map on the basis of the update of the digital map;
wherein the safety map contains safety-relevant information about a current road situation.

22. The update device as claimed in claim 17,
wherein the digital map is a navigation map.

23. An update system for updating digital maps for a multiplicity of vehicles, said update system having:
an update device as claimed in claim 17;
a control center for receiving measurement data from the update device and for transmitting update data to the update device;
wherein the control center is also configured to produce the update data on the basis of the measurement data.

24. The update system as claimed in claim 23,
wherein the control center is configured to individually transmit individualized update data to the multiplicity of vehicles.

25. The update system as claimed in claim 23,
wherein the control center is configured to receive measurement data from a multiplicity of communication units from different vehicles and to produce the update data on the basis of all received measurement data.

26. The update system as claimed in claim 23,
wherein the control center is configured to statistically condition the measurement data for the purpose of producing the update data.

27. The use of an update device as claimed in claim 17 in a vehicle.

28. A method for updating a digital map in a vehicle, said method comprising the following steps:
capturing measured values by a capture unit in the vehicle;
transmitting measurement data which are based on the measured values from the vehicle to a control center;
producing update data on the basis of the measurement data in the control center;
transmitting the update data, which are based on the measurement data, from the control center to an update device; and
updating the digital map on the basis of the update data.

29. The method as claimed in claim 28,
wherein said capturing step comprises at least one of the following sub-steps:
ascertaining a vehicle speed and a GPS position for the vehicle;
ascertaining distances from other vehicles using ambient sensors;
ascertaining information about the roadbase using an ESP sensor system;
ascertaining visibility conditions using an ambient sensor system;
ascertaining lanes using cameras; and
ascertaining interventions of an Antilock Braking System (ABS), an Electronic Stability Program (ESP), an Anti-Slip Regulation (ASR) system or any combination thereof.

30. The method as claimed in claim 28, wherein the update data transmission step is preceded by a comparison with data in the digital map.

31. A computer program product which, when executed on a processor, instructs the processor to perform the following steps:
capture measured values by a capture unit in a vehicle;
transmit measurement data which are based on the measured values from the vehicle to a control center;
update a digital map in the vehicle on the basis of update data which have been produced on the basis of the measurement data in the control center.

32. A computer-readable medium which stores a computer program product which, when executed on a processor, instructs the processor to perform the following steps:
capture measured values by a capture unit in a vehicle;
transmit measurement data which are based on the measured values from the vehicle to a control center;
update a digital map in the vehicle on the basis of update data which have been produced on the basis of the measurement data in the control center.
